(19) United States
(12) Patent Application Publication
(10) Pub. No.: US 2018/0125737 A1
(43) Pub. Date: May 10, 2018

(54) GOUT PAIN RELIEF STRAP SYSTEM

(71) Applicant: Pushpa Raje, Silver Spring, MD (US)

(72) Inventor: Pushpa Raje, Silver Spring, MD (US)

(21) Appl. No.: 15/805,423

(22) Filed: Nov. 7, 2017

Related U.S. Application Data
(60) Provisional application No. 62/419,954, filed on Nov. 9, 2016.

(51) Int. Cl. A61H 1/00; A61H 7/00

(52) U.S. Cl. CPC A61H 1/006; A61H 2205/12; A61H 2201/1642; A61H 7/001

(57) ABSTRACT

A gout pain relief and prevention strap system provides users with a bandage for preventing and reliving pain caused by gout arthritis. It allows wearers to sleep, walk, and perform other activities in a normal fashion without worry of pain. It offers a suitable alternative to modern medication such as pills and topical applications. This includes elastic or hook and loop fasteners which allow the bandage to be adjusted to a specific, desired size.

### CROSS REFERENCE TO RELATED APPLICATION

The present application is related to and claims priority to U.S. Provisional Patent Application No. 62/419,954 filed Nov. 9, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of medical bandages and more specifically relates to a gout pain and prevention strap.

### 2. Description of Related Art

A bandage is a piece of material used either to support a medical device such as a dressing or splint, or on its own to provide support to or to restrict the movement of a part of the body. When used with a dressing, the dressing is applied directly on a wound, and a bandage used to hold the dressing in place. Gout arthritis can be extremely painful and require medications or topical applications in order to obtain relief. It may be nearly impossible for people to go about their normal daily routine if he/she is suffering from extensive pain due to gout. Walking and sleeping may be extremely painful without any form of treatment. A suitable solution is desired.

U.S. Pub. No. 2006/0189914 to Jerome Slavitt relates to an h-wrap elastic bandage. The described h-wrap elastic bandage includes an elastic bandage having narrow extension portion to allow for beginning compression at a specified pedal digit or finger. the elastic bandage can be wrapped around the identified digit and remain in place, as required, by integrated fastening hooks. the elastic bandage may be further wrapped around the foot or hand, as appropriate, to provide compression at the surgical site, as well as positional overcorrection, if required.

### BRIEF SUMMARY OF THE INVENTION

In view of the foregoing disadvantages inherent in the known medical bandages art, the present disclosure provides a novel gout pain relief and prevention strap system. The general purpose of the present disclosure, which will be described subsequently in greater detail, is to provide users with a bandage for preventing and reliving pain caused by gout arthritis.

A gout pain relief and prevention strap system is disclosed herein. The gout pain relief and prevention strap system includes an elongated planar body having a first-side and a second-side defined by an outer perimeter and a thickness. The first-side and the second-side when formed together create a thickness. The elongated planar body is configured to provide compression when placed around a joint of a user-wearer and secured via at least one fastener. The at least one fastener is configured to attach to a material of the elongated planar body. The elongated planar body may include leather or other flexible materials. The elongated planar body is configured to wrap around the joint of a user-wearer for gout pain relief and prevention. The gout pain relief and prevention strap system offers a natural remedy to preventing and handling gout pain. Users can simply apply the device over an affected area for pain relief and prevention.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a gout pain relief and prevention strap system, constructed and operative according to the teachings of the present disclosure.

FIG. 1 is a perspective view of a gout pain relief and prevention strap system during an ‘in-use’ condition, according to an embodiment of the disclosure.

FIG. 2A is a perspective view of the gout pain relief and prevention strap system during an ‘in-use’ condition, according to an embodiment of the disclosure.

FIG. 2B is a perspective view of the gout pain relief and prevention strap system during an ‘in-use’ condition, according to an embodiment of the disclosure.

FIG. 3 is a perspective view of the gout pain relief and prevention strap system of FIG. 1, according to an embodiment of the present disclosure.

FIG. 4 is a perspective view of the gout pain relief and prevention strap system of FIG. 1, according to an embodiment of the present disclosure.

FIG. 5 is a perspective view of the gout pain relief and prevention strap system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to medical bandages and more particularly to a gout pain relief and prevention strap system as used to improve the prevention and relief of pain associated with gout.

Generally, the gout pain relief and prevention strap is a small adjustable bandage capable of being applied to areas of the body affected by gout arthritis. The device is comprised of a strap of flexible materials and elastic or hook and loop fasteners. It allows wearers to sleep, walk, and perform other activities in a normal fashion without worry of pain. It offers a suitable alternative to modern medication such as pills and topical applications. This includes elastic or hook and loop fasteners which allow the bandage to be adjusted to a specific, desired size. The present invention saves an extensive amount of money on medications and other methods of gout treatment.

The device contains no medication or topical applications, offering a natural remedy to handling gout pain. Users can simply apply the strap over an affected area for pain relief and prevention. Users can then walk, sleep, and perform other daily routine functions in a pain-free manner. Gout pain relief and prevention strap can be constructed using leather, elastic, and other suitable materials. The bandage may be available in various sizes in order to accommodate all user needs and preferences.

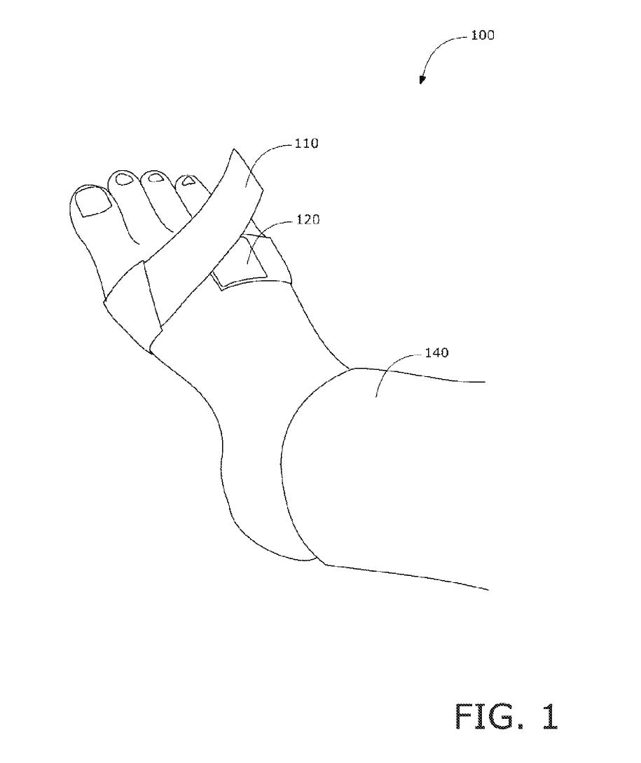

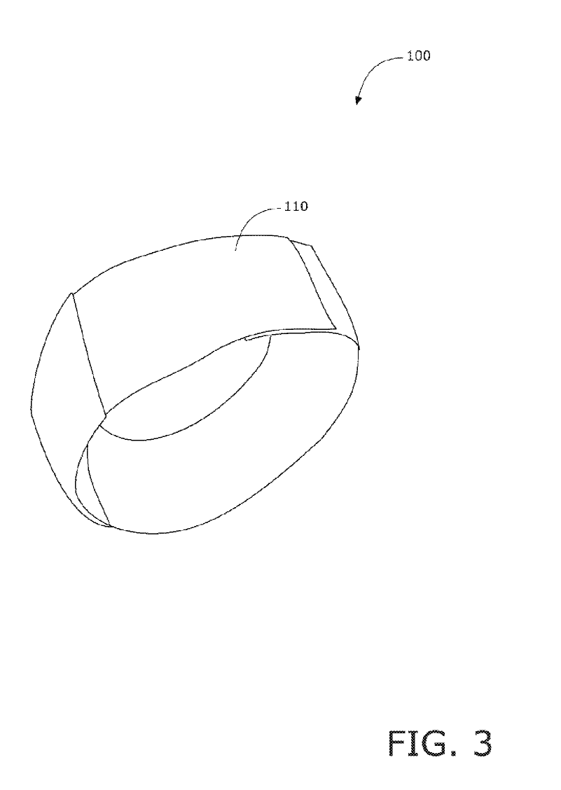

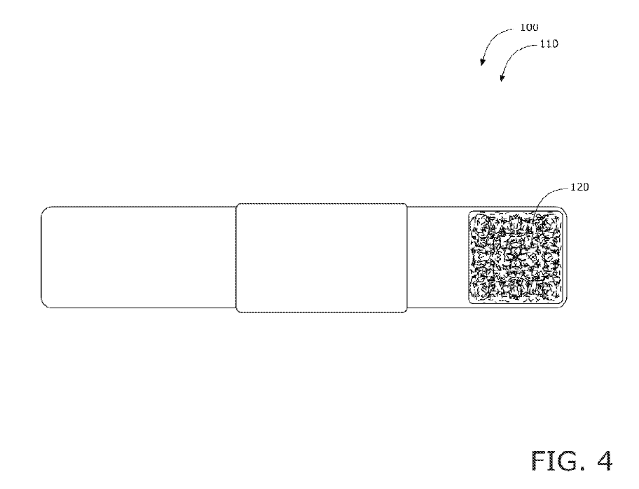

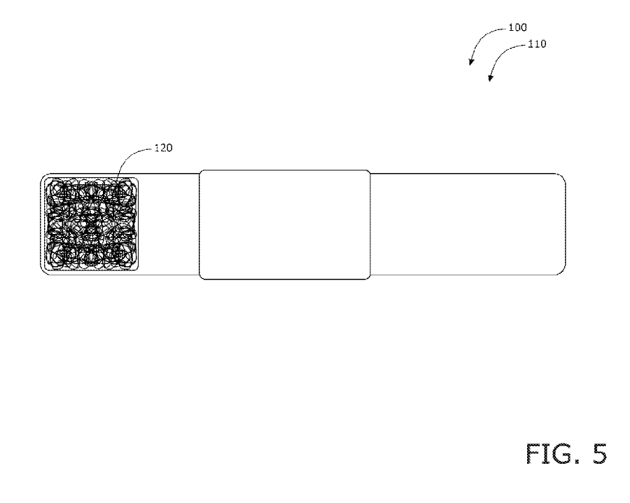

Referring now more specifically to the drawings by numerals of reference, there is shown in FIGS. 1-5, various views of a gout pain relief and prevention strap system 100. FIGS. 1-5 show a gout pain relief and prevention strap system 100 according to an embodiment of the present disclosure. As illustrated, the gout pain relief and prevention strap system 100 may include an elongated planar body 110 having a first-side and a second-side defined by an outer perimeter and a thickness. The first-side and the second-side when formed together create a thickness. The elongated planar body 110 is configured to be placed around a joint of a user-wearer 140 and secured via at least one fastener 120. The at least one fastener 120 is configured to attach to a material of the elongated planar body 110. The device is a suitable alternative to modern medication such as pills and topical applications for pain relief and prevention. In certain embodiments, the elongated planar body 110 includes a magnetic plate 138 (shallow bowl type) which helps reduce pain.

The elongated planar body 110 comprises a length-dimension greater than a width-dimension of the elongated planar body. The elongated planar body 110 is flexible and comprises elastic. The fastener 120 may include glue, hook and loop fasteners, or other suitable fasteners. Once wrapped around a joint, at least one fastener 120 is configured to secure elongated planar body 110 to a body of a user-wearer 140. The gout pain relief and prevention strap system 100 when wrapped around a joint provides compression and prevents and minimizes gout pain.

In a preferred embodiment, the width-dimension comprises a width of approximately 0.75-inches. The length-dimension comprises a length of approximately 1.75-inches to 2-inches. In other embodiments, the length-dimension comprises a length of 4-inches or other suitable length for different users. The length-dimension and width-dimension may vary to accommodate different joints.

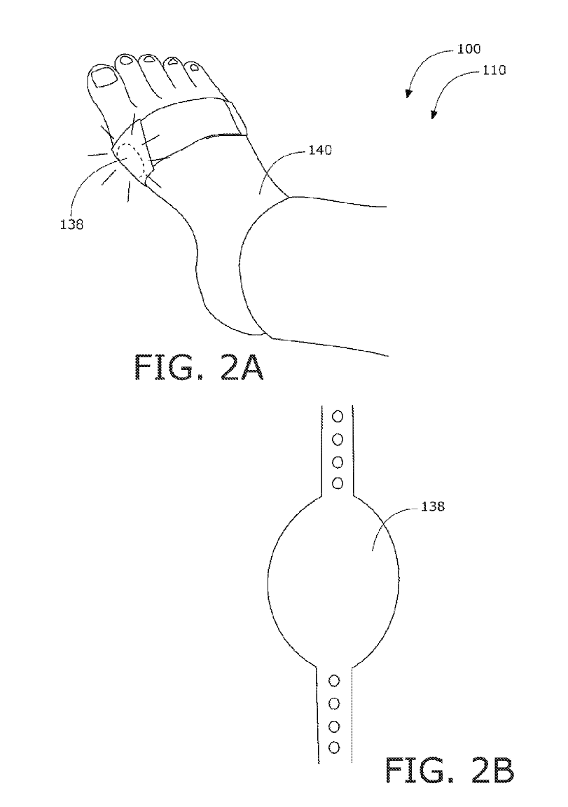

As shown in FIG. 2B the device may include a gel pack material elongated planar body 110 and may include button-fasteners along a band portion for adjusting the elongated planar body 110. The device may be one size fits all and may be wrapped around a foot. Dimensions may vary based on manufacturing.

The elongated planar body 110 may include leather or other flexible materials. The elongated planar body 110 is configured to wrap around the joint of a user-wearer 140 for gout pain relief and prevention. The gout pain relief and prevention strap system 100 does not contain medication or topical applications, offering a natural remedy to handling gout pain in preferred embodiments. User-wearers 140 can simply apply the device over an affected area for pain relief and prevention. A method of using the present invention may include providing the device described, applying the device to an affected area to compressively relieve gout pain and removing as needed.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A gout pain relief and prevention strap system comprising:
an elongated planar body having a first-side and a second-side defined by an outer perimeter and a thickness;
wherein said first-side and said second-side when formed together create a thickness; and
wherein said elongated planar body is configured to be placed around a joint of a user-wearer and secured via at least one fastener to promote gout relief via compressive means.

2. The gout pain relief and prevention strap system of claim 1, wherein said elongated planar body comprises a length-dimension greater than a width-dimension of said elongated planar body.

3. The gout pain relief and prevention strap system of claim 1, wherein said elongated planar body is flexible.

4. The gout pain relief and prevention strap system of claim 1, wherein said elongated planar body comprises elastic.

5. The gout pain relief and prevention strap system of claim 1, wherein said at least one fastener comprises hook and loop fasteners.

6. The gout pain relief and prevention strap system of claim 1, wherein said at least one fastener comprises glue.

7. The gout pain relief and prevention strap system of claim 1, wherein said at least one fastener is configured to secure elongated planar body to a body of a user-wearer.

8. The gout pain relief and prevention strap system of claim 2, wherein said width-dimension comprises a width of 0.75-inches.

9. The gout pain relief and prevention strap system of claim 2, wherein said length-dimension comprises a length of 2-inches.

10. The gout pain relief and prevention strap system of claim 2, wherein said length-dimension comprises a length of 4-inches.

11. The gout pain relief and prevention strap system of claim 2, wherein said length-dimension comprises a length of 1.75-inches and comprises hook and loop fasteners.

12. The gout pain relief and prevention strap system of claim 2, wherein said length-dimension comprises a length of 1.75-inches.

13. The gout pain relief and prevention strap system of claim 1, wherein said elongated planar body comprises a magnetic plate.

14. The gout pain relief and prevention strap system of claim 1, wherein said gout pain relief and prevention strap system does not comprise medication.

15. The gout pain relief and prevention strap system of claim 1, wherein said at least one fastener is configured to attach to a material of said elongated planar body.

16. The gout pain relief and prevention strap system of claim 1, wherein said elongated planar body is configured to wrap around said joint of a user-wearer for gout pain relief and prevention.

17. A gout pain relief and prevention strap system comprising:
an elongated planar body having a first-side and a second-side defined by an outer perimeter and a thickness;
wherein said elongated planar body comprises a length-dimension greater than a width-dimension of said elongated planar body;
wherein said elongated planar body is flexible;
wherein said elongated planar body comprises elastic;
wherein said at least one fastener comprises hook and loop fasteners;
wherein said at least one fastener is configured to secure elongated planar body to a body of a user-wearer;
wherein said first-side and said second-side when formed together create a thickness;
wherein said gout pain relief and prevention strap system does not comprise medication;
wherein said at least one fastener is configured to attach to a material of said elongated planar body;
wherein said elongated planar body is configured to be placed around a joint of a user-wearer and secured via at least one fastener; and
wherein said elongated planar body is configured to wrap around said joint of a user-wearer for gout pain relief and prevention.
